(19) United States
(12) Patent Application Publication
(10) Pub. No.: US 2023/0363560 A1
(43) Pub. Date: Nov. 16, 2023

(54) COLLAPSIBLE SUN SHADE APPARATUS

(71) Applicant: Ronald Dean Scott, Peoria, AZ (US)

(72) Inventor: Ronald Dean Scott, Peoria, AZ (US)

(21) Appl. No.: 17/745,348

(22) Filed: May 16, 2022

(51) Int. Cl. A47G 23/00; E04H 15/58; E04H 15/10

(52) U.S. Cl. CPC A47G 23/00; E04H 15/58; E04H 15/10

(57) ABSTRACT

A collapsible sun shade apparatus that includes a plurality of panels hinged to one another along respective edges thereof and is adapted to form a collapsible enclosure to thereby surround a drinking vessel, block solar radiation, and keep liquids therein cool.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

### 1. Field of the Invention

This invention relates generally to sun shades, and more specifically to a sun shade apparatus that is collapsible and shaped to form an enclosure adapted to surround a drinking vessel, block solar radiation, and keep liquids therein cool.

### 2. Description of the Related Art

Prior art sun shades are formed as foldable panels that are shaped to be placed adjacent a car window to block solar radiation from passing into a compartment of a vehicle. These prior art sun shades are not designed or adapted to form an enclosure to surround an item and keep the item and any liquids therein cool. As such, drinking vessels retaining chilled liquids in an outdoor environment are not properly protected from solar radiation and will be exposed to solar radiation and heated over time. Accordingly, the present invention overcomes the disadvantages associated with the prior art, by providing a collapsible sun shade apparatus that includes a plurality of panels hinged to one another along respective edges and adapted to form a collapsible enclosure to thereby surround a drinking vessel, block solar radiation, and keep liquids therein cool.

### BRIEF SUMMARY OF THE INVENTION

In view of the foregoing disadvantages inherent in the known types of sunshades in the prior art, the present invention provides a collapsible sun shade apparatus that is adapted to form an enclosure that can surround a drinking vessel. As such, the general purpose of the present invention, which will be described subsequently in greater detail, is to provide a collapsible sun shade apparatus that includes a plurality of panels hinged to one another along respective edges thereof and is adapted to form a collapsible enclosure to thereby surround a drinking vessel, block solar radiation, and keep liquids therein cool, with all the advantages of the prior art and none of the disadvantages.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

### BRIEF DESCRIPTION OF THE DRAWINGS

The figures which accompany the written portion of this specification illustrate embodiments according to the teachings of the present invention.

FIG. 1 shows a perspective view of the collapsible sun shade apparatus shading a drinking vessel according to the preferred embodiment of the present invention.

FIG. 2 shows a perspective view of the collapsible sun shade apparatus in a folded configuration according to the preferred embodiment of the present invention of FIG. 1.

FIG. 3 shows a front view of the of the collapsible sun shade apparatus according to the preferred embodiment of the present invention of FIG. 1.

FIG. 4 shows a side view of the of the collapsible sun shade apparatus according to the preferred embodiment of the present invention of FIG. 1.

FIG. 5 shows a back view of the of the collapsible sun shade apparatus according to the preferred embodiment of the present invention of FIG. 1.

The various embodiments of the present invention will hereinafter be described in conjunction with the appended drawings.

### DETAILED DESCRIPTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

The following embodiments and the accompanying drawings, which are incorporated into and form part of this disclosure, illustrate embodiments of the invention and together with the description, serve to explain the principles of the invention. To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

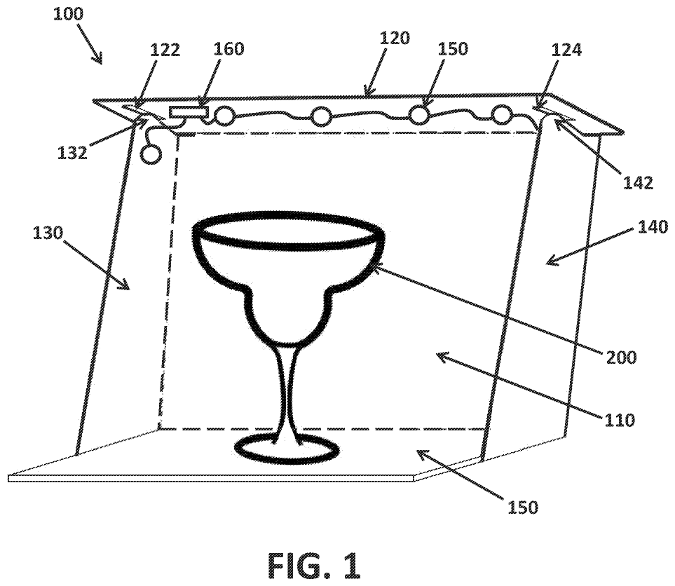

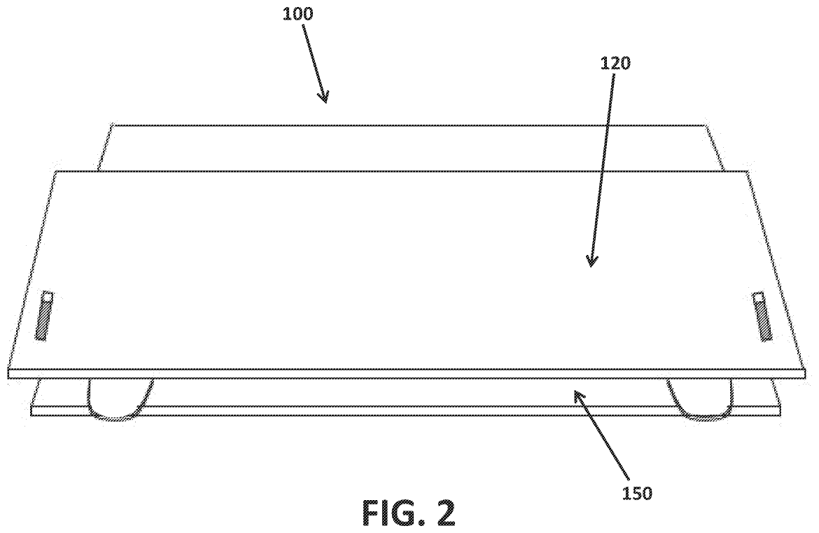

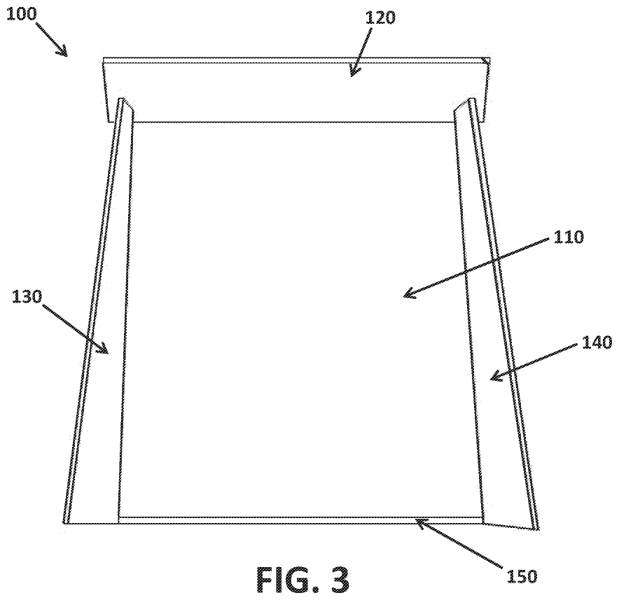

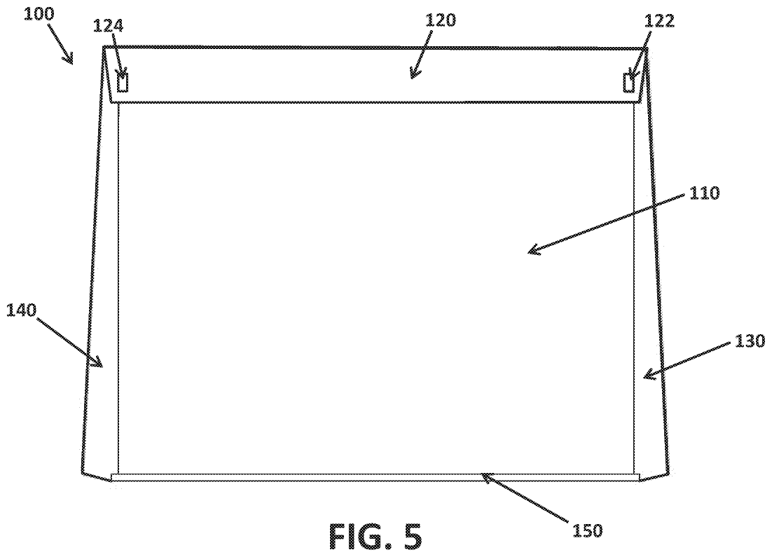

Turning now descriptively to drawing, referring to FIGS. 1-5, the present invention discloses a collapsible sun shade apparatus 100 adapted to form a collapsible enclosure to thereby surround a drinking vessel 200, block solar radiation, and keep liquids therein cool, wherein the collapsible sun shade apparatus 100 comprises a back panel 110 including a top edge, a first side edge, a second side edge, and a bottom edge; a top panel 120 including a front edge, a first side edge, a second side edge, a back edge, a first slot 122 located in proximity to the first edge, and a second slot 124 located in proximity to the second edge, wherein the back edge is pivotally connected to the top edge of the back panel, such that the top panel is pivotally connected to the back panel; a bottom panel 150 including a front edge, a first side edge, a second side edge, and a back edge, wherein the back edge is pivotally connected to the bottom edge of the back panel, such that the bottom panel is pivotally connected to the back panel; a first side panel 130 including a top edge including a first tab 132 adapted to be removably placed within the first slot 122 of the top panel, a front edge, and a back edge pivotally connected to the first side edge of the back panel, such that the first side panel is pivotally connected to the back panel, and a bottom edge adapted to be removably placed adjacent the first side edge of the bottom panel; and a second side panel 140 including a top edge including a second tab 142 adapted to be removably placed within the second slot 124 of the top panel, a front edge, a back edge pivotally connected to the second side edge of the back panel, such that the second side panel is pivotally connected to the back panel, and a bottom edge adapted to be removably placed adjacent the second side edge of the bottom panel, wherein the collapsible sun shade apparatus is adapted to be folded into a flat configuration for storage and transport, and an in-use configuration wherein the top panel, the bottom panel, and the side panels are pivoted, and wherein the first and second tabs are respectively placed within the first and second slots to thereby removably hold the collapsible sun shade apparatus in the in-use configuration and forming an enclosure; and wherein said collapsible sun shade apparatus is adapted to provide a surface for drinking vessels to be placed upon within said enclosure and be shaded from solar radiation.

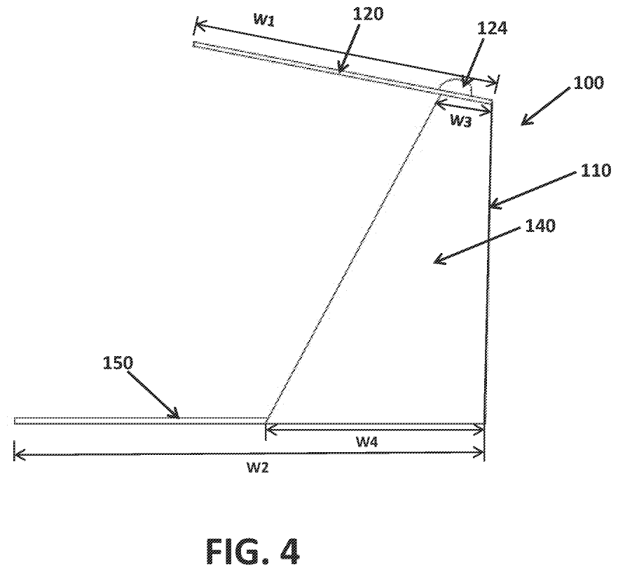

As shown in FIG. 4, the top panel 120 of the collapsible sun shade apparatus may have a width W1 defined between its back edge and its front edge, and the bottom panel 150 may have a width W2 defined between its back edge and its front edge, wherein the width W2 of the bottom panel is larger than the width W1 of the top panel. In the preferred embodiment the width W2 of the bottom panel is twice that of the width W1 of the top panel. Furthermore, the top edges of the first and second side panels have a width W3 defined between its back edge and its front edge, and the bottom edges of the first and second side panels has a width W4 defined between its back edge and its front edge, wherein the width of the bottom edges is larger than the width of the top edges. In the preferred embodiment the width W4 of the bottom edges is three times larger than the width W3 of the top edges.

As further shown in FIG. 4, the top edges of the first and second side panels are formed at an angle with respect to the bottom edges thereof, such that when in the in-use configuration the top panel is held at an angle to said bottom panel. In the preferred embodiment that angle is between 15 and 25 degrees.

The collapsible sun shade may further comprise light fixtures 150 attachable to the top panel and side panels and adapted to provide light within the enclosure, and a power source 160 electrically connected to and adapted to provide electric power to the light fixtures. In the preferred embodiment the light fixture are formed as LED lights, and the power source as a battery. The power source may also be formed as an electric wire releasably connected to an external power source.

In the preferred embodiment, the collapsible sun shade apparatus is made from a rigid material that is adapted to thermally insulate the enclosure. In some embodiments a waterproof material can be incorporated. Materials that may also be used include plastics, corrugated plastics, ABS plastic, fiberglass, aluminum, polyesters, vinyl coated polyesters, high-density polyethylene (HDPE), polyethylene, polycarbonate, bronze, nylons, synthetic nylons corrugated and non-corrugated cardboard with plastic coatings, combinations thereof, and any similar or the like.

The pivotal connections between the panels of the collapsible sun shade apparatus can be formed as weakened seams or perforations within the collapsible sun shade apparatus material, or in more complicated embodiments can be formed as metallic or fabric hinges or the like.

The size and the rectangular shapes of the panels may also vary depending on the size and shape of the desired enclosure. Furthermore, other attachment means may be used to releasably connect the side panels to the top panel, such as hook and loop material or bendable snaps. Furthermore, in some embodiments, the bottom edges of the side panels may also be releasably attached to the bottom panel using releasable attachment means

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention.

Although the invention has been explained in relation to its preferred embodiment, it is to be understood that many other possible modifications and variations can be made without departing from the spirit and scope of the invention.

What is claimed is:

1. A collapsible sun shade apparatus for use in shading drinking vessels from solar radiation, comprising:
a back panel including:
a top edge;
a first side edge;
a second side edge; and
a bottom edge;
a top panel including:
a front edge;
a first side edge;
a second side edge;
a back edge;
a first slot;
wherein said first slot is located in proximity to said first edge; and
a second slot;
wherein said second slot is located in proximity to said second edge;
wherein said back edge is pivotally connected to said top edge of said back panel, such that said top panel is pivotally connected to said back panel;
a bottom panel including:
a front edge;
a first side edge;
a second side edge; and
a back edge;
wherein said back edge is pivotally connected to said bottom edge of said back panel, such that said bottom panel is pivotally connected to said back panel;
a first side panel including:
a top edge including;
a first tab;
wherein said first tab is adapted to be removably placed within said first slot of said top panel;
a front edge;
a back edge;
wherein said back edge is pivotally connected to said first side edge of said back panel, such that said first side panel is pivotally connected to said back panel; and
a bottom edge;
wherein said bottom edge is adapted to be removably placed adjacent said first side edge of said bottom panel; and
a second side panel including:
a top edge including;
a second tab;
wherein said second tab is adapted to be removably placed within said second slot of said top panel;
a front edge;
a back edge;
wherein said back edge is pivotally connected to said second side edge of said back panel, such that said second side panel is pivotally connected to said back panel; and
a bottom edge;
wherein said bottom edge is adapted to be removably placed adjacent said second side edge of said bottom panel;
wherein said collapsible sun shade apparatus is adapted to be folded into a flat configuration for storage and transport, and an in-use configuration wherein said top panel, said bottom panel, and said side panels are pivoted, and wherein said first and second tabs are respectively placed within said first and second slots to thereby removably hold said collapsible sun shade apparatus in said in-use configuration and forming an enclosure; and
wherein said collapsible sun shade apparatus is adapted to provide a surface for drinking vessels to be placed upon within said enclosure and be shaded from solar radiation.

2. The collapsible sun shade apparatus of claim 1, wherein said top panel has a width defined between its said back edge and its said front edge; wherein said bottom panel has a width defined between its said back edge and its said front edge; and wherein said width of said bottom panel is larger than said width of said top panel.

3. The collapsible sun shade apparatus of claim 2, wherein said width of said bottom panel is twice that of said width of said top panel.

4. The collapsible sun shade apparatus of claim 1, wherein said top edges of said first and second side panels have a width defined between its said back edge and its said front edge; wherein said bottom edges of said first and second side panels has a width defined between its said back edge and its said front edge; and wherein said width of said bottom edges is larger than said width of said top edges.

5. The collapsible sun shade apparatus of claim 4, wherein said width of said bottom edges is three times larger than said width of said top edges.

6. The collapsible sun shade apparatus of claim 1, wherein said top edges of said first and second side panels are formed at an angle with respect to said bottom edges thereof, such that when in said in-use configuration said top panel is held at an angle to said bottom panel.

7. The collapsible sun shade apparatus of claim 6, wherein said angle is between 15 and 25 degrees.

8. The collapsible sun shade apparatus of claim 1, wherein said collapsible sun shade apparatus is made from a rigid material.

9. The collapsible sun shade apparatus of claim 1, wherein said collapsible sun shade apparatus is made from a material that is adapted to thermally insulate said enclosure.

10. The collapsible sun shade apparatus of claim 1, further comprising:
at least one light fixture;
wherein said at least one light fixture is attached to at least one of said top panel and side panels; and
wherein said at least one light fixture is adapted to provide light within said enclosure; and
a power source;
wherein said power source is electrically connected to and adapted to provide electric power to said at least one light fixture.

11. The collapsible sun shade apparatus of claim 10, wherein said at least one light fixture is formed as an LED light.

12. The collapsible sun shade apparatus of claim 10, wherein said power source is a battery.

13. A combination of a drinking vessel and a collapsible sun shade apparatus, comprising:
a drinking vessel;
wherein said drinking vessel is adapted to hold liquids therein for consumption; and
a collapsible sun shade apparatus comprising:
a back panel including:
a top edge;
a first side edge;
a second side edge; and
a bottom edge;
a top panel including:
a front edge;
a first side edge;
a second side edge;
a back edge;
a first slot;
wherein said first slot is located in proximity to said first edge; and
a second slot;
wherein said second slot is located in proximity to said second edge;
wherein said back edge is pivotally connected to said top edge of said back panel, such that said top panel is pivotally connected to said back panel;
a bottom panel including:
a front edge;
a first side edge;
a second side edge; and
a back edge;
wherein said back edge is pivotally connected to said bottom edge of said back panel, such that said bottom panel is pivotally connected to said back panel;
a first side panel including:
a top edge including;
a first tab;
wherein said first tab is adapted to be removably placed within said first slot of said top panel;
a front edge;
a back edge;
wherein said back edge is pivotally connected to said first side edge of said back panel, such that said first side panel is pivotally connected to said back panel; and
a bottom edge;
wherein said bottom edge is adapted to be removably placed adjacent said first side edge of said bottom panel; and
a second side panel including:
a top edge including;
a second tab;
wherein said second tab is adapted to be removably placed within said second slot of said top panel;
a front edge;
a back edge;
wherein said back edge is pivotally connected to said second side edge of said back panel, such that said second side panel is pivotally connected to said back panel; and
a bottom edge;
wherein said bottom edge is adapted to be removably placed adjacent said second side edge of said bottom panel;
wherein said collapsible sun shade apparatus is adapted to be folded into a flat configuration for storage and transport, and an in-use configuration wherein said top panel, said bottom panel, and said side panels are pivoted, and wherein said first and second tabs are respectively placed within said first and second slots to thereby removably hold said collapsible sun shade apparatus in said in-use configuration and forming an enclosure; and
wherein said collapsible sun shade apparatus is adapted to provide a surface for said drinking vessel to be placed upon within said enclosure and be shaded from solar radiation.

14. The collapsible sun shade apparatus of claim 13, wherein said top panel has a width defined between its said back edge and its said front edge; wherein said bottom panel has a width defined between its said back edge and its said front edge; and wherein said width of said bottom panel is larger than said width of said top panel.

15. The collapsible sun shade apparatus of claim 13, wherein said top edges of said first and second side panels have a width defined between its said back edge and its said front edge; wherein said bottom edges of said first and second side panels has a width defined between its said back edge and its said front edge; and wherein said width of said bottom edges is larger than said width of said top edges.

16. The collapsible sun shade apparatus of claim 13, wherein said top edges of said first and second side panels are formed at an angle with respect to said bottom edges thereof, such that when in said in-use configuration said top panel is held at an angle to said bottom panel.

17. The collapsible sun shade apparatus of claim 13, further comprising:
at least one light fixture;
wherein said at least one light fixture is attached to at least one of said top panel and side panels; and
wherein said at least one light fixture is adapted to provide light within said enclosure; and
a power source;
wherein said power source is electrically connected to and adapted to provide electric power to said at least one light fixture.

18. The collapsible sun shade apparatus of claim 17, wherein said at least one light fixture is formed as an LED light.

19. The collapsible sun shade apparatus of claim 17, wherein said power source is a battery.
